(19) United States
(12) Patent Application Publication
(10) Pub. No.: US 2026/0346887 A1
(43) Pub. Date: Nov. 5, 2026

(54) TRACK SIDE INSTALLATION FOR RAIL MONITORING

(71) Applicant: University of Pittsburgh - Of the Commonwealth System of Higher Education, Pittsburgh, PA (US)

(72) Inventors: Piervincenzo Rizzo, Pittsburgh, PA (US); Matthew Belding, Pittsburgh, PA (US); Charles Clemenes Hager, Pittsburgh, PA (US)

(73) Assignee: University of Pittsburgh - Of the Commonwealth System of Higher Education, Pittsburgh, PA (US)

(21) Appl. No.: 19/662,989

(22) Filed: Apr. 29, 2026

Related U.S. Application Data
(60) Provisional application No. 63/796,982, filed on Apr. 29, 2025.

(51) Int. Cl. B61K 9/08; G01N 29/04; G06N 3/0464

(52) U.S. Cl. CPC B61K 9/08; G01N 29/045; G06N 3/0464

(57) ABSTRACT

An apparatus includes a striker assembly including a base, a striker coupled to the base, a spring coupled to the striker, a spring compressor coupled to the spring to compress the spring and selectively release the striker to strike a continuous welded rail (CWR), and one or more fasteners coupled to the base and configured to removably secure the striker assembly in relation to the CWR. A method includes receiving continuous welded rail (CWR) vibration signal from a CWR striker system that impacts a CWR and detects a vibration signal in response, and estimating a rail neutral temperature of the CWR by processing CWR vibration signal data associated with the vibration signal through a convolutional neural network trained on previously obtained CWR vibration signal data and ground truth RNTs associated with the previously obtained CWR vibration signal data.

### CROSS REFERENCE TO RELATED APPLICATION

This application claims the benefit of U.S. Provisional Patent Application No. 63/796,982, filed Apr. 29, 2025, and is incorporated by reference herein.

### ACKNOWLEDGMENT OF GOVERNMENT SUPPORT

This invention was made with government support under FR19RPD3100000022 awarded by the Federal Railroad Administration and under the University Grand Challenge Master Contract No. 20-0701-007537 provided by the Association of American Railroads (AAR). The government has certain rights in the invention.

### FIELD

The field is non-destructive testing and monitoring of railroad equipment.

### BACKGROUND

Rail neutral temperature (RNT) is the temperature at which the average longitudinal stress at a given section of a continuous welded rail (CWR) is zero. When the temperature of the rail is below (or above) the RNT, longitudinal tension (or compression) is developed. When extreme compression overcomes the track lateral resistance, permanent track deformation due to buckling may occur. Extreme tension may instead lead to rail fracture. Current methods to determine axial stress are partly disruptive. Thus, a need exists for improved systems and techniques.

### SUMMARY

According to an aspect of the disclosed technology, an apparatus includes a striker assembly including a base, a striker coupled to the base, a spring coupled to the striker, a spring compressor coupled to the spring to compress the spring and selectively release the striker to strike a continuous welded rail (CWR), and one or more fasteners coupled to the base and configured to removably secure the striker assembly in relation to the CWR.

According to another aspect of the disclosed technology, a method includes positioning a striker assembly in relation to a continuous welded rail (CWR) for measurement of a rail neutral temperature (RNT), such that the positioning does not interfere with a top surface of the CWR, striking a side surface of the CWR using the striker assembly, and detecting with a detector of the striker assembly that is coupled to the CWR, a vibration signal that is associated with the RNT of the CWR and that is produced in response to the striking of the CWR.

According to a further aspect of the disclosed technology, a method includes receiving continuous welded rail (CWR) vibration signal from a CWR striker system that impacts a CWR and detects a vibration signal in response, and estimating a rail neutral temperature of the CWR by processing CWR vibration signal data associated with the vibration signal through a convolutional neural network trained on previously obtained CWR vibration signal data and ground truth RNTs associated with the previously obtained CWR vibration signal data.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic of a measurement system that can be used to probe a continuous welded rail (CWR) with a striker, detect produced vibrations, and estimate a rail neutral temperature (RNT) based on the detected vibrations.

FIG. 2 is a top view schematic of a striker assembly that can be used to strike and detect vibrations in a CWR.

FIG. 3 is a schematic of a selective striker release system.

FIG. 4 is a top view schematic of a vibration detection system having a compact form factor.

FIG. 5 is an example of a machine learning framework for training an artificial neural network to estimate RNT and for using the trained network in the field.

FIG. 6 is a schematic of a computing device that may be used to estimate a RNT.

FIG. 7 is a schematic of a RNT measurement system.

FIG. 8 is a flowchart of a method of striking a CWR, detecting vibrations, and estimating RNT.

FIG. 9 is a flowchart of a method data filtering acquired vibration data.

FIG. 10 is schematic of a 1-dimensional convolutional neural network architecture used to extract features from the power spectral densities in the vertical and lateral directions.

FIG. 11 is a graph of RNT calculated from a strain gage rosette of an experiment vs the RNT predicted with an example MLA. The dashed lines indicate ±2.78 °C offsets from the bisector. 50% of the cleansed data from each day of the experiment was used for training and the remaining 50% was used for testing.

FIG. 12 is a graph of RNT calculated from a strain gage rosette vs the RNT predicted with the MLA. The dashed lines indicate ±2.78 °C offsets from the bisector. 50% of the cleansed data from each day was used for training and the remaining 50% was used for testing.

FIG. 13 is a graph of RNT calculated from a strain gage rosette vs the RNT predicted with the MLA. The dashed lines indicate ±2.78 °C offsets from the bisector. 50% of the cleansed data from each day was used for training and the remaining 50% was used for testing.

FIG. 14 is an image of a track-side monitoring system that is deployed while a train travels along the CWR.

FIG. 15 is a schematic of an experimental test setup.

FIG. 16 is a graph of the results of a blind test of rail temperature measurements and rail neutral temperature predictions, conducted at NS in Pittsburgh in June 2024.

FIG. 17 is a schematic of another experimental test setup.

FIG. 18 is a graph of the results of a blind test of rail temperature measurements and rail neutral temperature predictions, conducted at NS in Pittsburgh in July 2024.

FIG. 19 is a pair of images of mounted standoffs on ties (left) and a close-up of pegs that prevent device kickback when a shaft is released (right).

FIG. 20 is a schematic of another experimental test setup.

FIG. 21 is a graph of the results of a blind test of rail temperature measurements and rail neutral temperature predictions, conducted at NS in Pittsburgh in August 2024.

FIG. 22 is a schematic of a 2-dimensional convolutional neural network architecture used to extract features from the power spectral densities in the vertical and lateral directions using spectral images.

FIG. 23 is a schematic juxtaposing 1D and 2DCNNs data representations. FIG. 24 is a graph of RNT calculated with a strain gage rosette vs. the RNT predicted with a 2DCNN. The dashed lines indicate ±2.78 °C offsets from the bisector. 50% of the cleansed data from each day was used for training and the remaining 50% was used for testing. (Compare with FIG. 13 which shows the predictive performance of a 1DCNN.) FIG. 25 is a graph of the results of a blind test of rail temperature measurements and rail neutral temperature predictions, conducted at NS in Pittsburgh in June 2024. (Compare with the bottom of FIG. 16 which shows the predictive performance of a 1DCNN.)

FIG. 26 is a graph of the results of a blind test of rail temperature measurements and rail neutral temperature predictions, conducted at NS in Pittsburgh in July 2024. (Compare with the bottom of FIG. 18 which shows the predictive performance of a 1DCNN.)

FIG. 27 is a set of graphs with the top row showing the empirical cumulative distribution functions (ECDFs) of Wasserstein analysis for training and test sets across all features (baseline=training, target=test), the middle row showing ECDFs of r Wasserstein analysis for baseline training vs NS June target set across all features (baseline=training, target=June NS data), and the bottom row showing ECDFs of Wasserstein analysis for baseline training vs target NS July test across all features (baseline=training, target=July NS data).

### DETAILED DESCRIPTION

### Overview

Minimally invasive nondestructive evaluation (NDE) or monitoring methods able to determine longitudinal stress and RNT are highly desirable because they can avoid the existing partially disruptive approaches to RNT measurement. Disclosed examples include wayside systems able to estimate the RNT and thereby the longitudinal stress in CWR. Example systems can trigger and measure low frequency vibrations and signal processing is performed to convert time domain data into frequency domain data. For example, power spectral densities (PSD) can be calculated and then utilized as the input data of a one-dimensional convolutional neural network (1DCNN), which extracts and relates the PSDs to the RNT. However, it will be appreciated that other approaches for converting time domain data to frequency domain may be used (e.g., FFT, STFT, etc.). A prototype system was tested at a controlled facility with known RNT and at two revenue service lines. The 1DCNN was trained with data collected during three field visits and eleven days of testing at two control facilities. The same network was then used to estimate blindly two revenue service lines. The results of the blind tests were promising.

Several examples disclosed herein present significant improvements over prior systems and techniques. For example, disclosed wayside installation system examples were designed and tested to allow for frequent measurements and monitoring of any railroad track without interfering with normal train operation or maintenance activities. Further, many examples can leverage new machine learning algorithms that are based on deep learning which can combine known physics-based insights related to rail vibration with the computational power of convolutional neural networks (CNN). These new MLAs can address the limitations of traditional techniques reliant on manual feature creation. Disclosed deep learning strategies were validated by using data collected during numerous different experiments conducted over several years (three field visits and eleven days of testing at two controlled loop facilities in Pueblo (CO) in 2021, 2022, and 2024) and then blindly tested at three revenue service lines.

### Introduction to CWR and Importance of RNT

With the advent of high-speed rail and the increase of tonnage moved by freight transportation, the use of continuous welded rails (CWR) has increased significantly worldwide. The mechanical and dynamic behavior of a CWR is a function of the track resistance, rail temperature, misalignment, as well as other secondary variables. When the temperature T_{R} of a given rail is above the so-called rail neutral temperature (RNT) T_{N}, defined as the temperature at which the longitudinal stress is zero, the rail is subject to longitudinal compression. When the compressive stress OR become extreme, buckle may occur. Statistics from the U.S. Federal Railroad Administration (FRA) show that over the last decade, buckling was the second most expensive cause of damage in the U.S., under the category Track, Roadbed and Structures. Current state-of-the-art (SOTA) methods are mostly invasive and target the measurement of OR, from which the RNT is estimated using the well-known relationship:

T_{N}=T_{R}−σ_{R}/Eα (1)
where E and α are the Young's modulus and the coefficient of thermal expansion of the steel, respectively. The rail cutting method is a destructive approach in which the whole cross-section of a given rail is cut, and the previous stress is estimated by measuring the gap at the cut. Owing to its nature, the method must be performed at cool temperature when the rail is under tension. The longitudinal stress is zero at the cut but progressively changes to the pre-cut stress value at a location that can be hundreds of meters away. Such force difference is denoted as the longitudinal force profile and the length of the rail having reduced internal longitudinal force is referred to as the influence zone. The rail cutting method is part of the so-called rail destressing, which is a common approach to manage RNT that encompasses rail cutting, de-anchoring (releasing the rail from constraints), rail pulling (pretensioning to close the gap), reconnecting by welding, and re-anchoring. The knowledge of that pretensioning at that given temperature enables to determine the new RNT using Eq. (1). The operation is followed by bonding strain gauges on the rail web and adopt a Wheatstone bridge circuit, where gauge outputs caused by lateral bending and temperature are compensated for. “VERSE” is a static semi-invasive method that links the axial force to the vertical force required to lift 30 meters of unanchored rail by a certain amount.

Over the last three decades nondestructive evaluation (NDE) methods based on electromagnetism, ultrasounds, acoustics, high-frequency vibration, and optics have emerged to improve upon SOTA limitations. Vibration-based methods are one of the earliest approaches ever proposed. They are based on the physical evidence that longitudinal stress alters the natural vibration frequencies and modal characteristics of beams and beam-like structures, including CWR. However, any vibration-based monitoring system faces a critical challenge: the effect of the boundary conditions. In CWR, the vibrations are not solely influenced by axial loads but by other factors, such as fasteners, sleepers' materials, distance between consecutive crossties, and environmental variability. These factors add complexity to an already challenging problem.

To address these challenges, Machine Learning (ML) has emerged as a powerful tool to identify the complex patterns and relationships within data, making them well-suited to account for the multifactorial influences on rail vibrations. Over the last few years, NDE techniques have been developed based on the measurement of low-frequency (<1 kHz) rail vibrations, and the computation of the corresponding power spectral densities (PSD) to train a machine learning algorithm (MLA) to predict the RNT. Those works focused on the experimental verification of the research hypotheses in the laboratory and in the field, as well as on the development of the MLA trained and tested with the experimental data. Disclosed examples further improve on these techniques.

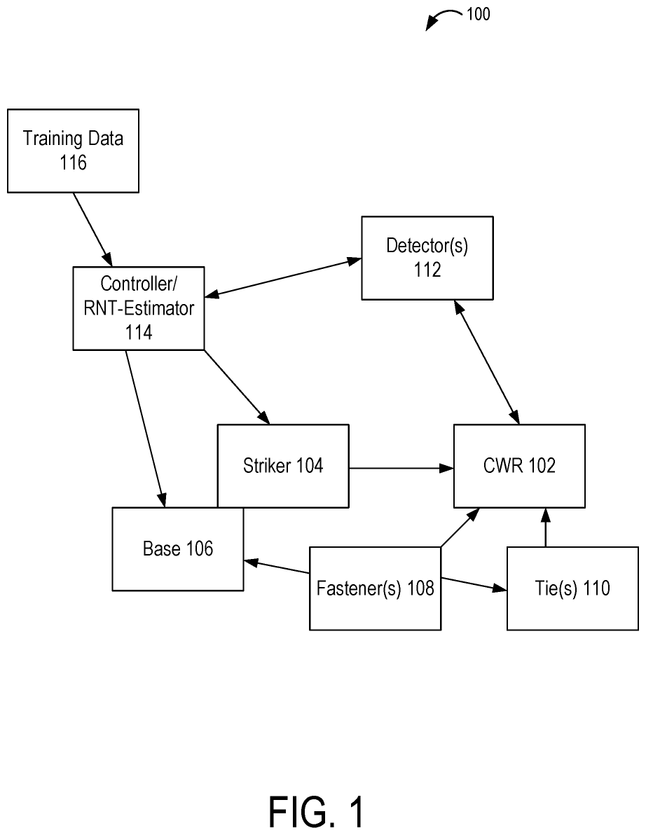

FIG. 1 is an example measurement system 100 for measuring the RNT of a CWR 102. The system 100 can include a striker 104 coupled to a base 106. The striker 104 can be positioned in proximity to the CWR 102, e.g., adjacent to the CWR, so that the striker 104 can strike the CWR 102 to produce vibrations in the CWR 102. Advantageously, the striker 104 can impact the CWR without interfering with top of the CWR. The striker 104 and base 106 can comprise a striker assembly, though other parts of the system 100 can also be part of the striker assembly. One or more fasteners 108, such as clamps, screws, standoffs, posts, magnets, etc., can be used to removably secure the striker assembly in relation to the CWR 102. In some examples, the fasteners 108 can removably secure the base 106 to consecutive railroad ties 110 (also referred to as sleepers). In further examples, the fasteners 108 can removably secure the base 106 to the CWR 102 (e.g., without securing the base 106 in relation to other parts of the railway system, including the ties). The striker 104 can include or be part of an actuator having various forms, e.g., a gear-driven spring-loaded rod, electric solenoid driven spring-loaded rod, an electric plunger (e.g., a solenoid actuator), a hammer, pendulum, etc.

The system 100 can further include one or more detectors 112 that can be coupled to the CWR 102 to detect vibrations in the CWR produced in response to the striking of the CWR 102 by the striker 104. In many examples, the detectors 112 are accelerometers, which can be wired or wireless. In further examples, non-contact lasers may be used (e.g., performing interferometry, such as laser Doppler vibrometry). A controller 114 can be in communication with the striker assembly to control operation of the striker 104 and with the detector 112 to receive vibration signal data. The controller 114 can include at least one processor and memory configured to store processor-executable instructions. With these instructions, the controller 114 can control the striker 104 to strike the CWR in a selective manner, e.g., at particular coordinated times so that detection timings can be mapped to striker events, and for a predetermined number of times in order to collect a set of data that can be averaged for estimation purposes.

In some examples, the detector 112 and/or controller 114 can be housed or supported by the base 106 (e.g., as part of the striker assembly), and in further examples, the detector 112 and/or controller 114 can be separately housed or supported. In some examples, the controller 114 can also be configured to produce RNT estimates based on the vibration data collected from the detectors 112. For example, the controller 114 can be configured to estimate the RNT of the CWR 102 by processing vibration data through a convolutional neural network trained on training data 116, e.g., previously obtained detected vibration signals from other CWRs and ground truth RNTs associated with the previously obtained detected vibration signals.

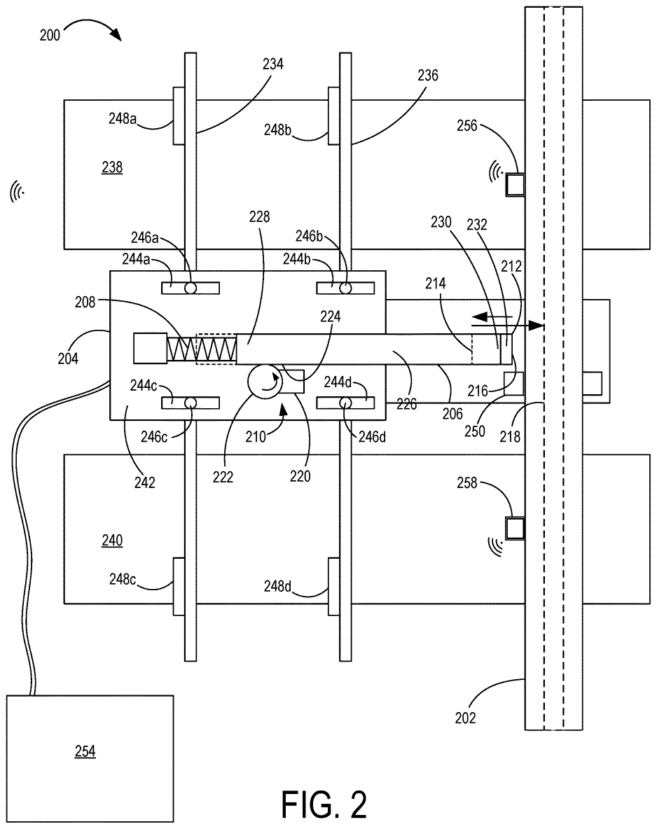

FIG. 2 is an example of a striker assembly 200 that can be used to strike a CWR 202. The striker assembly 200 includes a base 204, a striker 206 coupled to the base 204 with a spring 208, and a spring compressor 210 coupled to the spring 206. The spring compressor 208 coupled to compress the spring 208 and to further selectively release the striker 206 to strike the CWR 202. For example, the striker 206 can be at a rest position 212 and the spring 208 can be compressed by the spring compressor 210 to cause the striker 206 to be moved to a spring-loaded position 214. The spring compressor 210 can then cause the release of the striker 206 so that an impact end 216 of the striker 206 contacts a sidewall 218 of the CWR 202.

In some examples, the spring compressor 210 can include a motor 220 such as a stepper motor and a gear 222 coupled to the motor 220 and rotatably engaged to side surfaces 224 of the striker 206. The motor 220 can be coupled to the base 204 and be configured to controllably rotate the gear 222 to push against the surfaces 224. This can, in turn, cause the striker 206 to translate rearward and thereby compress the spring 208.

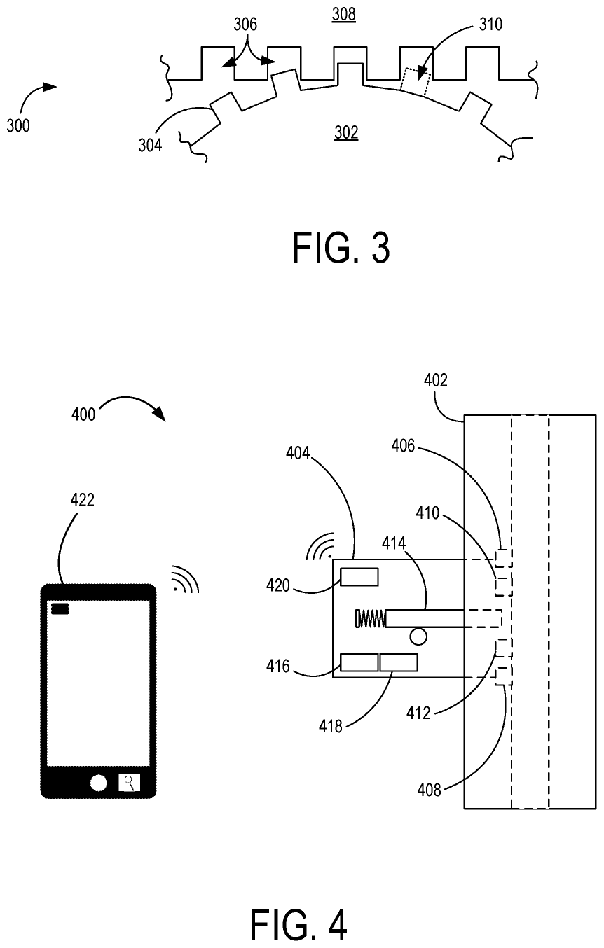

A selective striker release system 300 for a striker such as the striker 206 is shown in FIG. 3. A gear 302 can include teeth 304 (four shown) that can be configured to rotatably engage notches 306 (five shown) on a striker 308. For example, notches 306 can be formed by forming circumferential grooves of a cylindrical shaft forming part of the striker 308. The gear 300 can include a toothless portion 310, e.g., where one or more gear teeth are removed or shortened. As the gear 302 which is engaged to the notches 306 rotates to the toothless portion 310, the gear 302 can become momentarily disengaged with the notches 306 allowing for the selective release of the spring-loaded striker 308 to strike a continuous welded rail (CWR).

Referring back to FIG. 2, the striker 206 can include a rod portion 226 that extends longitudinally between a first end 228 that can be coupled to the spring 208 and an opposing second end 230 that can correspond to the impact end 216. In many examples, the side surfaces 226 of the rod portion 226 can include notches, e.g., similar to notches 306. The rod portion 226 can have a cylindrical cross-section though other cross-sections are possible, such as square, rectangular, etc. The rod portion 226 can be made of brass or other materials. In some examples, the second end 230 can include a replaceable tip 232 that can be changed based on wear or environment.

In some examples, the base 204 can include one or more supports, such as two supports 234, 236, that can extend transversely with respect to a direction of movement of the striker 206 when it is released to strike the CWR 202. The supports 234, 236 can extend to couple to two consecutive ties (sleepers) 238, 240 that support the CWR 202. In some examples, the supports 234, 236 can be rigid extensions of the base 204 and in further examples the supports 234, 236 can be secured to a baseplate 242 of the base 204, e.g., through slots 244a-244d in the baseplate 242 and fasteners 246a-246d. The slots 244a-244d may be used to adjust the positioning of the baseplate 242 relative to the supports 234, 236, e.g., in the direction of movement of the striker 206. One or more fasteners 248a-248d can be used to secure the supports 234, 236 to the ties 238, 240. For examples, clamps, screws, or adhesives may be used.

Some examples of the striker assembly 200 can include standoff members, e.g., corresponding to the fasteners 248a-248d, that can be coupled at first ends to the supports 234, 236 and extend downwards to couple at seconds ends to the two consecutive ties 238, 240. The standoff members can rest on the ties 238, 240 and be secured by weight and friction or alternatively can be secured with additional structures, such as pins, screws, etc. In some examples, the base 204 can extend to the rail 202 and in some examples can extend underneath the rail 202 to the other side of the rail (typically interior). Some examples can include one or more posts 250 extending from the base 204 at a position adjacent to the CWR. The one or more posts 250 can be configured to reduce a kickback associated with release of the spring 208. Examples in which the base 204 extends underneath the rail 202 can be secured to relative to the rail, e.g., with a fastener 252, such as a clamp.

In some examples, the striker assembly 200 can include or be coupled to a controller 254 and can include or be coupled to one or more vibration detectors (e.g., accelerometers) 256, 258. As shown, the detectors 256, 258 are wirelessly coupled to the controller 254, though wired examples may be used as well. The controller 254 can be configured to control various characteristics of the striking with the striker 206, such as timing, repetition rate, number of repetitions, etc. The controller 254 can also be in communication to receive data corresponding to the vibration signals detected with the detectors 256, 258. In many examples, the controller 254 can also be configured to estimate the RNT and/or stress in the rail based on the detected vibration data and one or more machine learning models.

FIG. 4 is example vibration detection system 400 for estimating rail neutral temperature in a rail 402. As shown, the system 400 has a relatively compact form factor and can include a housing 404 that can include fasteners 406, 408 which can be used to secure the housing 404 to the rail 402, e.g., without coupling to an intermediate structure such as a railway tie. While two fasteners are shown, one or more than two can be used in various examples. In many examples, the fasteners 406, 408 are magnets. The housing 402 can support vibration sensors 410, 412 that can be coupled to the rail 402 (typically through direct contact though indirect contact can be possible as well, e.g., with laser sources like a small-scale laser Doppler vibrometer). In some examples, the fastening of the housing 404 can include the fastening of the sensors 410, 412 to the rail 402 (e.g., again through magnets) or alignment of the sensors 410, 412 relative to the rail 402 for subsequent detection.

The housing 404 can support other components of the system 400, such as a striker assembly 414 (spring-based or otherwise) and a controller 416. The controller 416 can control the operation of the striker assembly 414 and be in communication with the sensors 410, 412 to receive vibration signal data in association with rail strikes. In many examples, the sensors 410, 412 can be conveniently wired directly to the controller 416 given the compact system environment. A rechargeable battery 418 can be used to power the detection system 400. In some examples, the housing 404 can support a wireless communication framework 420 (Bluetooth, WiFi, 5G, cellular, etc.) so that collected data and/or RNT estimates can be communicated wirelessly, e.g., to a maintenance worker's mobile device 422. In the field, the system 400 can be deployed and retrieved quickly to perform RNT estimates, or can be deployed and left in place for an extended duration. Given its relatively small size and ease of handling, in many examples numerous units can be deployed without requiring professional oversight.

### Machine Learning Implementations

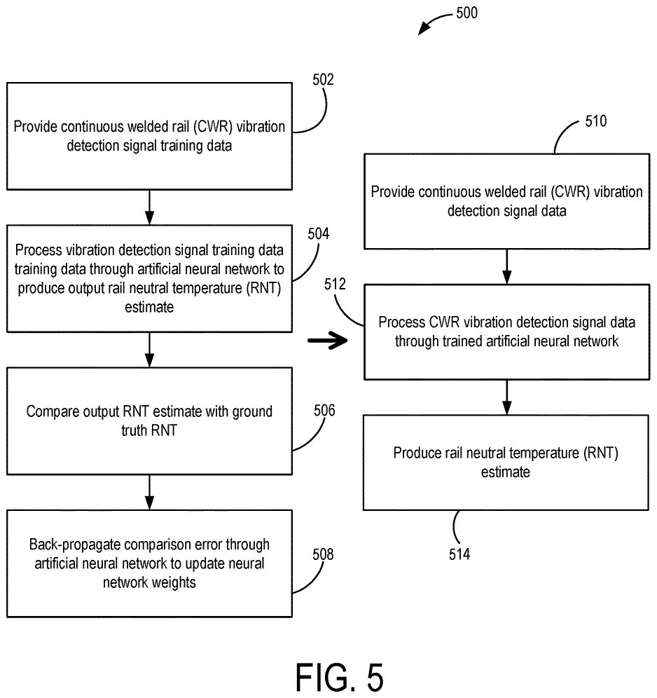

FIG. 5 is an example of machine learning framework 500 using an artificial neural network, such as a convolutional neural network, that can be used to estimate RNT. The framework 500 can include a training portion 502-508 that can be configured to refine parameters of the artificial neural network, e.g., to improve output accuracy as additional training data sets are processed. At 502, a set of CWR vibration detection signal training data is provided to the artificial neural network. Training data typically includes a set of vibration signal data obtained for various rails under different environmental conditions, locations, rail types, etc., with accompanying known ground truth rail neutral temperature (e.g., corresponding to measurements obtained through alternative detectors). At 504, the training data is processed through the artificial neural network to produce an RNT estimate as an output. At 506, the output RNT estimate is compared to the ground truth RNT associated with the training data to determine a comparison error. At 508, the artificial neural network is updated, e.g., by updating activations of one or more network layers by back-propagating (e.g., through gradient descent) the comparison error through the artificial neural network.

A measurement phase 510-514 can be used on rails to be measured for RNT, after the artificial neural network is sufficiently trained. At 510, vibration data can be provided as an input to the trained artificial neural network. Vibration data can be collected for a rail of interest by striking the rail with a striker (e.g., with various stikers described herein) and detecting vibrational response characteristics. The vibration data is typically filtered, cleansed, and normalized to provide it in a suitable form for processing by a trained artificial neural network. At 512, the data are processed through the trained artificial neural network, and at 514 an RNT estimate is produced as an output based on the input vibration data.

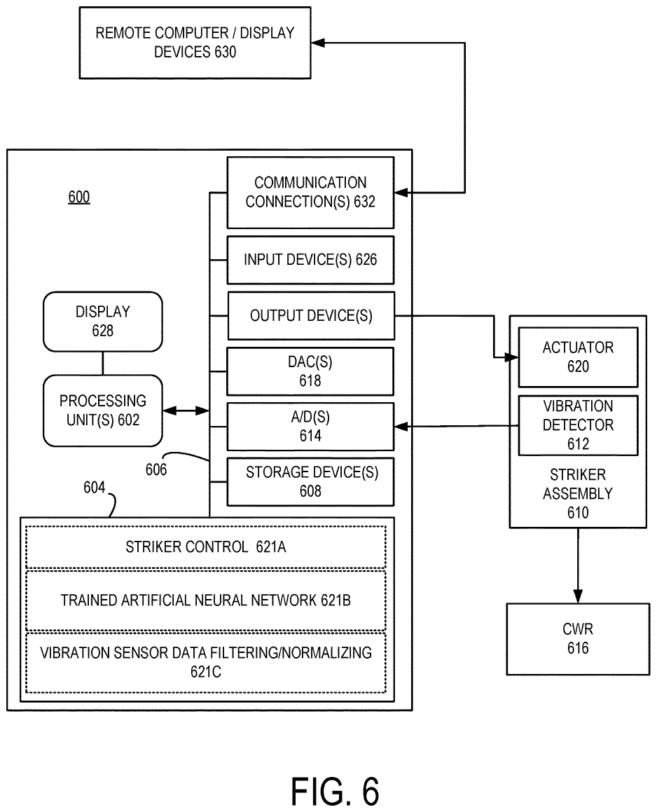

FIG. 6 shows another example implementing vibration detection on a hardware platform, such as a computing device 600. In general, the following discussion provides a brief, general description of an exemplary computing environment in which the disclosed vibration detection and RNT estimation techniques may be implemented. Although not required, the disclosed technology is described in the general context of computer-executable instructions, such as program modules, being executed by a computing unit, dedicated processor, multiple processors, or other digital processing system or programmable logic device. Generally, program modules include routines, programs, objects, components, data structures, etc., that perform particular tasks or implement particular abstract data types. Moreover, the disclosed technology may be implemented with other computer system configurations, including hand-held or mobile devices, personal computers (PCs), multiprocessor systems, microprocessor-based or programmable consumer electronics, network PCs, minicomputers, mainframe computers, dedicated processors, MCUs, PLCs, ASICs, FPGAs, CPLDs, systems on a chip, and the like. The disclosed technology may also be practiced in distributed computing environments where tasks are performed by remote processing devices that are linked through a communications network. In a distributed computing environment, program modules may be located in both local and remote memory storage devices. For example, processing (including striker control, vibration data filtering, machine learning tool processing (such as with an ANN)) can be distributed between local and remote devices. In some examples, intensive processing can be dedicated to remote computers or mobile devices.

With reference to FIG. 6, an exemplary system for implementing the disclosed technology includes the computing device 600 that includes one or more processing units 602, a memory 604, and a system bus 606 coupling various system components, including the system memory 604, to the one or more processing units 602. The system bus 606 may be any of several types of bus structures including a memory bus or memory controller, a peripheral bus, and a local bus using any of a variety of bus architectures. The memory 604 can include various types, including volatile memory (e.g., registers, cache, RAM), non-volatile memory (e.g., ROM, EEPROM, flash memory, etc.), or a combination of volatile and non-volatile memory. The memory 604 is generally accessible by the processing unit 602 and can store software in the form computer-executable instructions that can be executed by the one or more processing units 602 coupled to the memory 604. In some examples, processing units can be configured based on RISC or CISC architectures, and can include one or more general purpose central processing units, application specific integrated circuits, graphics or co-processing units or other processors. In some examples, multiple core groupings of computing components can be distributed among system modules, and various modules of software can be implemented separately.

The computing device 600 can further include one or more storage devices 608 such as a hard disk drive, flash drive, etc., which can be connected to the system bus 606 by a storage communications interface. The drives and their associated computer-readable media provide nonvolatile storage of computer-readable instructions, data structures, program modules, and other data for the computing device 600. Other types of non-transitory computer-readable media which can store data that is accessible by a computing device may also be used in the exemplary computing environment. The storage 608 can be removable or non-removable and can be used to store information in a non-transitory way and which can be accessed within the computing environment.

The computing device 600 can be coupled through one or more analog to digital converters (A/Ds) 614 to one or more vibration detectors 612 that are coupled to the computing device 600 that form part of a striker assembly 610 or that are separate from the striker assembly 610. Thus, in some examples, the computing device 600 (or selected parts of the computing device 600) can be integrated into the striker assembly 610 that can be coupled to a CWR 616 to be measured. During operation, the vibration detector 612 detects vibration characteristics (e.g., vibration frequencies and amplitudes that varies over time) associated with striking the CWR 616 with the striker assembly 610. The vibration detector 612 detects the vibrations produced in response to the strikes to produce a detector vibration signal, typically in the form an electrical current that varies over time based on the detected vibration characteristics. The vibration detector 612 sends the vibration signal to the computing device 600 for signal analysis and production of an RNT estimate for the rail 616. The computing device 600 can include digital to analog converters (DACs) 618 coupled to the bus 606, e.g., for control of external analog devices, such as an actuator 620 to produce the vibrations in the CWR 616. Various actuators may be used, such as a solenoid-controlled striker, transducer, a stepper motor used to spring load a striker of the striker assembly 610, etc.

The software, e.g., stored in the memory 604 at 621A, can automate the acquisition of vibration data by controlling the timing and other characteristics of the actuator 620 to generate suitable strike characteristics and corresponding vibrations in the CWR 616. The memory at 621B can include a trained artificial neural network (such as a CNN) that can be configured to receive vibration signal data as an input and RNT or related characteristic as an output. In some examples, the software, e.g., stored in the memory 621C, can be configured to filter and normalize the acquired vibration signal data into a form for submission to the trained artificial neural network stored at 621B.

In addition to the above, a number of program modules (or data such as vibration signal data) may be stored in the storage devices 608 including an operating system, one or more application programs, other program modules, and program data. A user may enter commands and information into the computing device 600 through one or more input devices 626 such as a keyboard, a pointing device such as a mouse, or control buttons to initiate striking and vibration data acquisition or to display a RNT estimate. Other input devices may include a digital camera, microphone, satellite dish, scanner, display, or the like. These and other input devices are often connected to the one or more processing units 602 through a serial port interface that is coupled to the system bus 606, but may be connected by other interfaces such as a parallel port or universal serial bus (USB), or integrated wiring. A display 628 such as an LCD display, monitor, or other type of display device can also be connected to the system bus 606 via an interface, such as a video adapter. Some or all data and instructions (e.g., strike timing, repetition, strike force, etc.) can be communicated with a remote computer 630 through communication connections 632 (e.g., wired, wireless, etc.) if desired. In some examples, the remote devices 630 can include one or more mobile devices or other computing devices that can be used to provide processing and/or RNT estimation using the acquired vibration data. In such examples, the computing device 600 can have pared down functionality sufficient to provide integration of the computing device 600 with the striker assembly 610 as a robust, deployable RNT estimation unit for track side application.

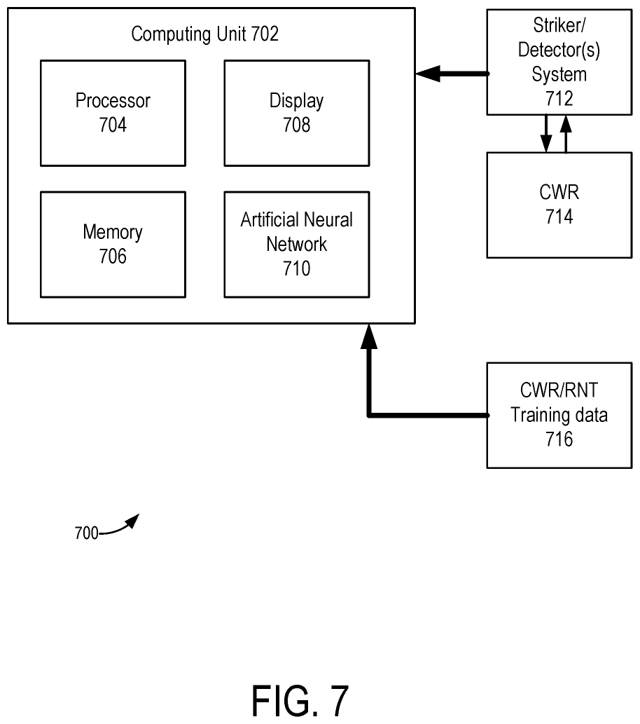

FIG. 7 is an example RNT measurement system 700 that can be part of various devices described herein, correspond to components of various devices described herein, and/or configured to implement various methods described herein. The system 700 includes a computing unit 702 that can include one or more processors 704, memory 706, a display 708, and various software routines, such as a trained artificial neural network 710. The computing unit can be coupled to a CWR striking and detection system 712 that is coupled to an CWR 714 to carry out vibration signal data acquisition of the CWR 714 and related RNT estimation with the acquired data. The trained artificial neural network 710 can receive vibration signal data from the striking and detection system 712, such as detected vibration characteristics. In some examples, the processor 704 can be configured to filter and normalize the acquired data for processing by the artificial neural network 710, e.g., according to any of the techniques described herein. The artificial neural network 710 can be trained with training data 716, e.g., with previously obtained vibration data and ground truth RNT values for other CWRs in various settings.

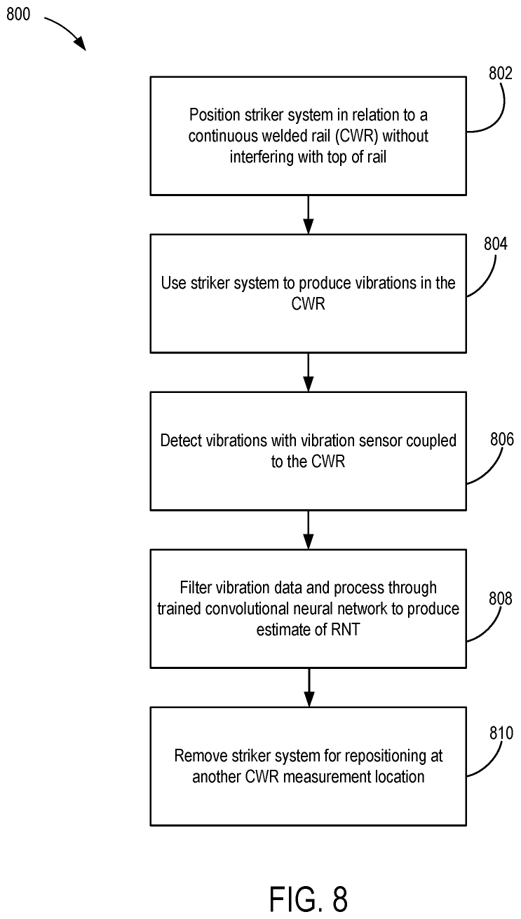

FIG. 8 is an example RNT measurement method 800 that includes, at 802, positioning a striker system in relation to a CWR, preferably without interfering with the top of the rail. In this way, the striker system can be deployed without interfering the normal usage of the railway system. At 804, the striker system is used to strike the CWR to produce vibrations in the CWR. Vibrations in the CWR are detected at 806, e.g., with vibration sensors coupled to the CWR. At 808, the vibration sensor data is acquired, filtered, normalized, and processed through a trained convolutional neural network to produce an estimate of RNT for the CWR. At 810, the striker system can be removed and then repositioned at another CWR measurement location to produce additional RNT estimates. Estimates can be performed locally or the vibration data can be transmitted for processing and estimating RNT remotely, e.g., through Bluetooth or other wireless (or wired) communication modules that communicate the vibration data to one or more mobile devices, such as a smartphone or other smart device.

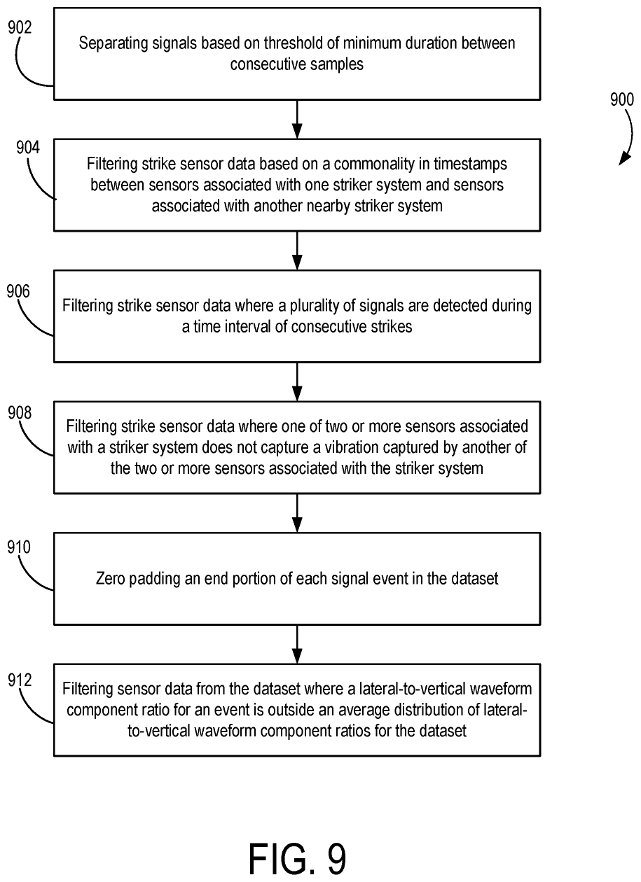

FIG. 9 is an example of a method of data filtering acquired vibration data for producing estimates with an artificial neural network. At 902, vibration data signals acquired from strikes on a CWR can be separated based on a threshold of minimum duration between consecutive samples. At 904, the sensor data can be filtered based on a commonality in timestamps between sensors associated with one striker system and sensors associated with another nearby striker system, other false positives, or other improper triggering. At 906, striker sensor data can be filtered where a plurality of signals are detected during a time interval between planned consecutive strikes. For example, double or multiple impacts can occur during a single strike which can then be filtered. At 908, strike sensor data can be filtered where one of two or more sensors associated with a striker system does not capture a vibration captured by another of the two or more sensors associated with the striker system. This can show an absence of synchronized detection where more than one sensor is present and can thereby indicate a faulty strike or sensing problem. At 910, striker sensor data can be filtered by retaining a portion of a vibration collection event (e.g., the vibration response from a strike) and zeroing subsequent noise after the impact. For example, the first 200 ms of an event can be retained while zeroing the remaining 800 ms (for a total of 1 s event). In some examples, the data can be zero-padded to correspond to a selected frequency resolution. At 912, the acquired sensor data can be further filtered by filtering sensor data from the data sets where a lateral-to-vertical waveform component ratio for an event is outside an average distribution of lateral-to-vertical waveform component ratios for the dataset. This removal can improve the accuracy of model outputs as ratio outliers tend to be indicative of substandard strike delivery.

The use of wireless accelerometers and the automatic nature of the example impact mechanisms bring the potential for false positives/negatives. In the present context, false positives are waveforms accidentally recorded by the vibration sensors and unrelated to any individual strike by the striker. False negatives represent vibrations triggered by the striker but not recorded by the sensor(s). As such, raw waveforms can be post-processed (data cleansing or filtering) to remove false positives, and to identify and eventually remove outliers generated by unwanted interferences. Such cleansing can minimize measurement errors that could lead to inaccurate predictions, build a high-quality dataset for deep learning, and lay the foundation for the automatic processing of data in any wayside installation. Data cleansing strategies can include various steps, which in many examples can be performed consecutively.

A first step can be signal separation. For example, in an experiment, each LORD G-Link-200-40G accelerometer stored all the detected signals into a single file. As such, the first step consisted of separating the individual signals and allocating them to an individual file, which contained three vectors: time, lateral acceleration, and vertical acceleration. The separation was done by calculating the time difference between two consecutive samples. Differences higher than one second marked the end of a signal and the beginning of the next waveform. A second step can filter improper triggering. A 2024 experimental setup paired one wayside striker rod to the two closest wireless sensors. To remove any signal associated with the vibration triggered by the farthest strike the start time of each waveform from each sensor was cross compared. When the same timestamp was seen in all four signals, the two signals triggered by the far striker rod were removed. A third step can filter double impacts. For example, a given accelerometer can record two consecutive signals separated by a time interval much shorter than the two consecutive strikes set by the user (e.g., 20 seconds). In addition, some sensors failed to fully capture the signal from an impact, leading to shorter signal lengths. Also in this case, the signal and its companion from the paired sensor were removed from further analysis. A fourth step can involve signal synchronization. The vibration generated by any given impact was expected to be captured simultaneously by the two closest sensors. If one of the sensor pairs failed to capture the vibration, the captured signal was discarded. A fifth step can involve zero padding. For example, for 1 s signal collections, the first 200 ms of each signal were retained with the remaining 800 ms zeroed to remove subsequent noise after the impact. During the power spectral density (PSD) calculations, each window also can be zero-padded to produce a frequency resolution of 0.1 Hz. A sixth step can filter based on a lateral-to-vertical component ratio. The ratio of the peak-to-peak (ppk) amplitude of the lateral to the vertical waveform components can be calculated, and the mean μ and standard deviation σ can be computed. Signals with ratios outside the range of μ+3 σ can be removed, along with the corresponding signals recorded by the paired sensor. In many examples, because the striker impact is strictly applied laterally, any significant vertical component compared to the lateral counterpart should have been caused by a poor strike. Also, this last step eliminated automatically those few signals with ppk amplitudes below 0.5 g or above 100 g.

Various machine learning algorithms may be used, such as convolutional neural networks, recurrent neural networks, support vector machines, random forests, etc. In some examples, the machine learning algorithm architecture can include a 1-dimensional convolutional neural network (1DCNN) that is configured to use only a normalized frequency spectrum of the vertical and lateral components of the detected vibrations as the input. In further examples, a 2-dimensional CNN (2DCNN) may be used in which spectral images can serve as inputs to the CNN, e.g., vertical and lateral spectral images. The deep learning approach benefits from the ability of the convolution operation to automatically extract relevant spatial features in the frequency domain when mapping to a target value, in this case rail neutral temperature, which is contrary to which previous approaches used the entire PSDs for the feature space. Additionally, removal of the rail temperature as an input allows for one less measurement for this technique. Through automatic feature extraction, the estimations have been to produce accurate results while avoiding onerous operator requirements associated with manual feature extraction. Thus, many disclosed machine learning examples can avoid reliance on interpretable models or starting with specific physical insights related to CWRs and RNTs (like resonant frequency shifts, peak picking, etc.).

Data preparation for the model can include performing a min-max normalization of the PSDs across a 0-700 Hz range (e.g., after data filtering and cleansing discussed above). This removes bias caused by amplitude deviations across sensors and uncertainty associated with the strength of the hammer impact. The lateral components from both sensors can then be combined into a single vector using frequency domain decomposition (FDD). This includes computing the PSD matrix at a given frequency range (e.g., 0-700 Hz, though other ranges are possible) and performing singular value decomposition of the matrix to obtain the singular values at 0-700 Hz. The FDD normally involves a last step of peak picking, but in many disclosed examples, this was not performed as it was left to the 1DCNN or 2DCNN to extract relevant frequency features. After combining into a single vector, the 1DCNN can be fed with a 2-dimensional input vector that consists of the two FDD amplitudes in both the vertical and lateral direction, treating each direction as a channel in the input. In the case of 2DCNNs, in some examples the data can be a reshaped or restructured form of the 1D combined PSD data.

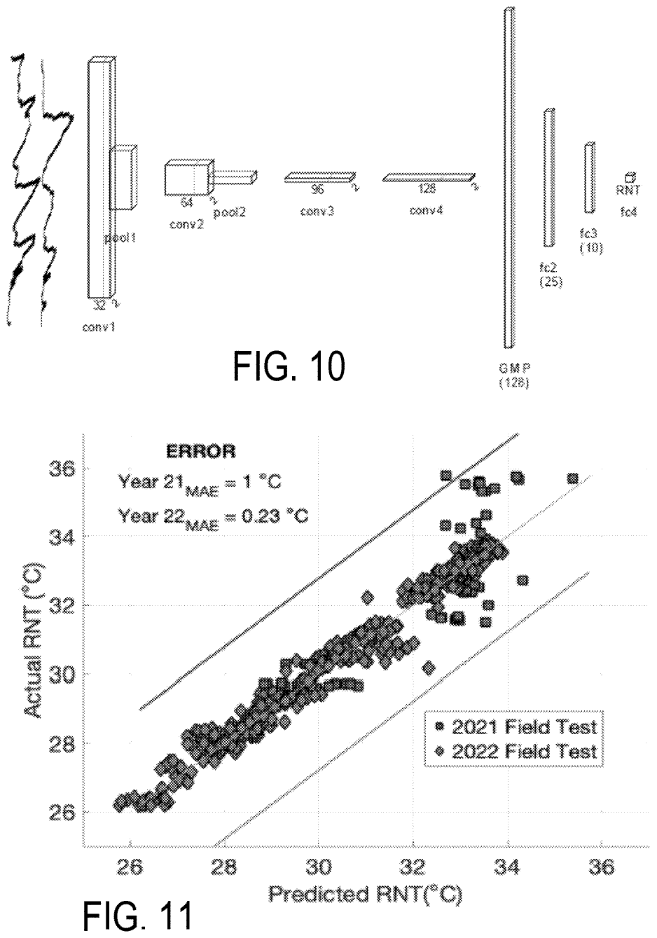

Example models can be trained considering several existing deep learning techniques. These can include layer normalization and max pooling layers. The former is used to correct any covariate drift in the features during learning while the latter is used to reduce the spatial dimensions of the original frequency spectrum input. In total for a particular 1DCNN example, the feature extractor (which can be referred to as the backbone of the network) consisted of four 1-dimensional convolution layers where all but the last two layers were followed by a leaky relu activation, layer normalization, and 1-dimensional max pooling layer. Leaky relu does not suffer from dead neurons like traditional relu due to its nonzero negative region. The second to last convolution layer (conv3) contains no max pooling layer while the last (conv4) was slightly modified to a global max pooling (GMP) layer that is the max of all features extracted along the reduced frequency dimension instead of the max of every n feature (as done with max pooling). The two max pooling layers contained pool sizes of three and five with strides of four on both. All convolution layers contained a filter size of five with number of filters growing with multiples of 32 on each subsequent layer. To complete construction of the model, the learned 128 features from the GMP layer were used as input to three fully connected layers with 25, 10, and 1 node, respectively. The last node uses a linear activation function to allow for a continuous output when determining the RNT while the previous two use a standard relu activation function. In all, 107,100 weights were learnable in the training process of the 21-layer model, which is shown for clarity in FIG. 10. To avoid overfitting, the best validation loss was monitored using the Mean Squared Error (MSE), defined as:

$$MSE = \frac{1}{n} {\sum }_{i = 1}^{n} {( {Y}_{i} - {\hat{Y}}_{i} )}^{2} \qquad ( 2 )$$

where, Yᵢ is the true RNT, Ŷᵢ is the predicted RNT, and n represents the number of samples. MSE calculates the mean square residual error between the predicted value and target, where the square assists in penalizing larger residual predictions. A period of 200 epochs was used to train alongside a validation split of 15% and test split of 50%. MSE was used as the loss function for training while the Mean Absolute Error (MAE):

$$MAE = \frac{1}{n} {\sum }_{i = 1}^{n} {\vert {Y}_{i} - {\hat{Y}}_{i} \vert}^{2} \qquad ( 3 )$$

was used for validating the model because this value measures the mean absolute residual error between the predicted value and target without penalizing outliers like the MSE. Adam was chosen as the optimizer with a learning rate of 0.01 given its adjustable learning rate and faster convergence. Also, weights were adjusted every 64 signals by using a minibatch size of 64.

### Experimental Results and Track Testing

Three analyses were conducted. In the first analysis the deep learning model was trained using 2021 and 2022 data to estimate the RNT at the Transportation Technology Center (TTC) tracks. The same trained model was then used to estimate the RNT of the MxV FAST loop track. Both facilities are located in Pueblo (CO). In the third analysis the model was trained using data from all 11 days on the field to estimate the RNT at both field sites.

In the first analysis, training and validation was performed with data previously acquired from 2021/2022 field tests. To construct the training and test split, a stratified sampling approach was taken randomly using half of the dataset, i.e., 50% of the data, from each sensor and each day. This included the 15% of which was used to validate the performance of the model during training. The prediction was conducted by feeding the remaining dataset unseen by the algorithm during the training process. FIG. 11 compares the RNT predicted with the MLA against the RNT estimated independently by TTC. The bisector indicates the ideal case of a perfect match whereas the two dashed parallel lines are ±2.78 °C (or ±5 °F) distant from the ideal bisector and represent a desirable accuracy. The MAE associated with both years is presented as well. The MAE related to 2022 is smaller than the MAE associated with 2021, likely due to the different number of measurements taken the second year in comparison to the first year. As a result, 2022 was able to account for a wider margin of rail temperatures resulting in errors that were larger than those of 2022. Despite this, all the predicted values are well within the ±2.78 °C (or ±5 °F) offset from the ideal bisector, demonstrating adequate learning in the training process to unseen data.

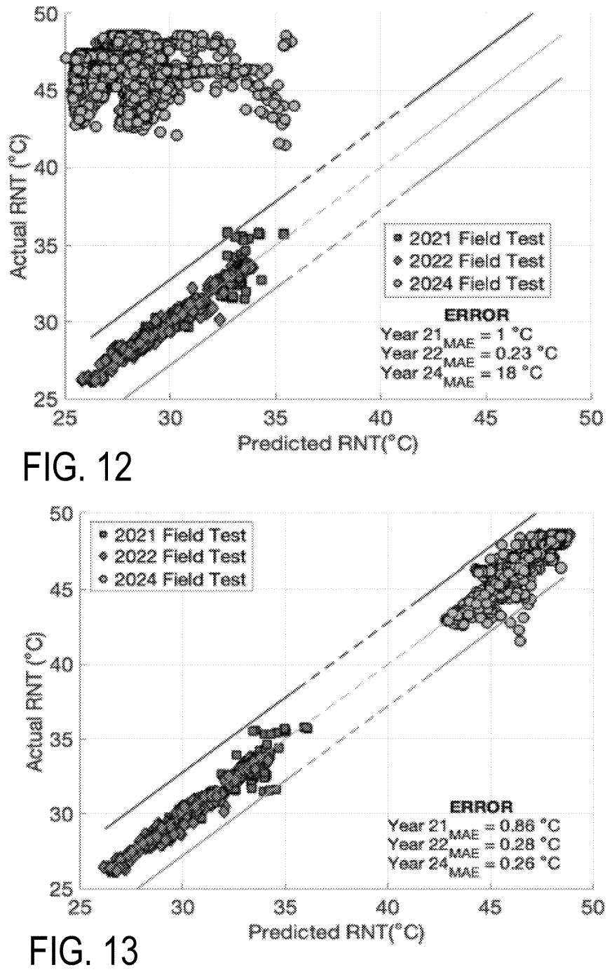

The same trained 1DCNN was used to infer the neutral temperature of the rail at the FAST Loop facility. This inference can be labeled as “blind test” because the MLA was not trained to learn any pattern relative to the 2024 dataset. The results are presented in FIG. 12 that, similar to what is seen in FIG. 11, compares the neutral temperature estimated by the 1DCNN with the RNT calculated from the strain gage readings. For the ground truth 2024 values, data from strain gage #2 in that experiment were considered. This strain gage was chosen because its readings were in between the other two gages. As can be seen, the MAE related with 2021 and 2022 are identical as the same training and the same testing data were used. However, FIG. 12 shows that the model was unable to provide an accurate estimation of the neutral temperature. This is because the scenarios, i.e., the T_{N}, to be recognized were never seen before by the network. The deep learning was based on Ty that was between 26 and 35 °C, whereas the data to be assessed by the network laid between 4° and 50 °C, substantially higher compared to previous field tests. It is also likely that the track at the FAST Loop significantly differs from those previously seen by the network. In other words, the network was challenged to recognize a physical condition never seen before, which makes it difficult to generalize to new resistances without prior knowledge.

The deep learning model was retrained by randomly selecting 50% of the data from each sensor and each of the 11 days in the field. The same validation split of 15% in the training set was used. The results are presented in FIG. 13 and demonstrate a dramatic improvement in the estimation of the RNT as it pertains to the MxV test location. This corroborates the hypothesis discussed above about the poor performance seen in FIG. 12, i.e., the lack of training data representative of the conditions of the site to be assessed. Since the training dataset was different, the MAE associated with the 2021 and 2022 field sets is different than what seen in FIG. 11 and FIG. 12.

The results presented in FIG. 13 also confirm that the MLA can learn the relationship between RNT and low frequency vibration even for a broad range of temperatures and highlight the need for a dataset that is representative of multiple track conditions.

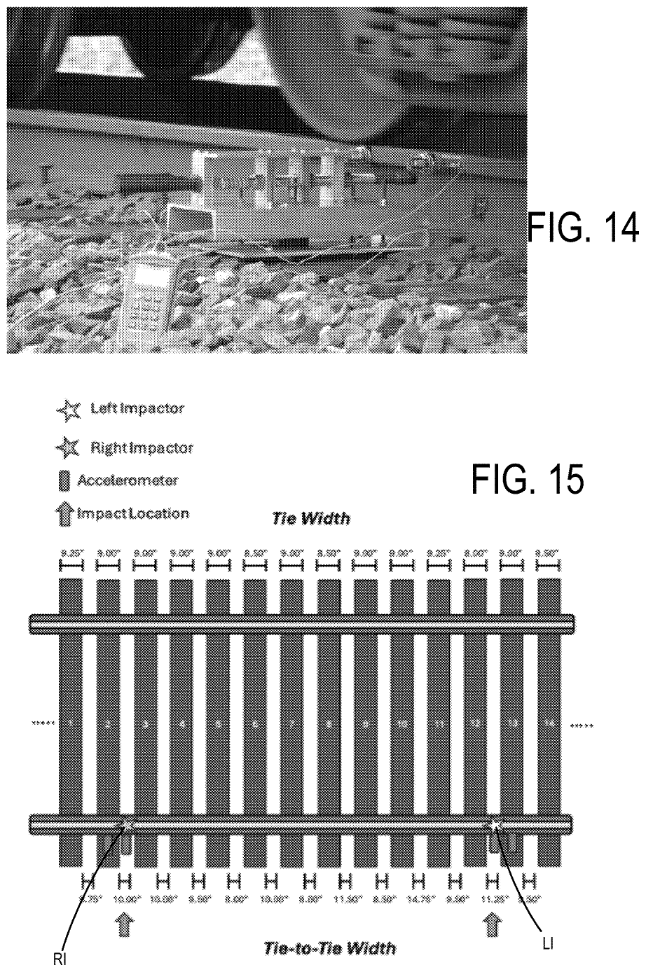

Revenue service tracks were also tested. Two wayside units were installed on a parallel 60-mph tangent track on wooden sleepers. One test was completed in June 2024 and a second test was completed nearly at a same location but at a different line in July 2024. On both occasions, the tracks were closed only to install and remove the equipment, and then kept open to regular operations, as demonstrated by the photo in FIG. 14. The track was not instrumented with strain-gages. For the first experiment, two units were clipped to the foot of the rail and placed approximately 3 meters (10 feet) apart, as schematized in FIG. 15. This differed from the Pueblo setup by requiring no clipping/fastening to the ties. This new arrangement generated several cross-triggers and about 38% of the stored signals were removed during the post-processing using filtering strategies associated with improper triggering discussed above. Still, 982 signals were retained. The same 1DCNN model shown in FIG. 10 was used for inference on the field tests in Pittsburgh.

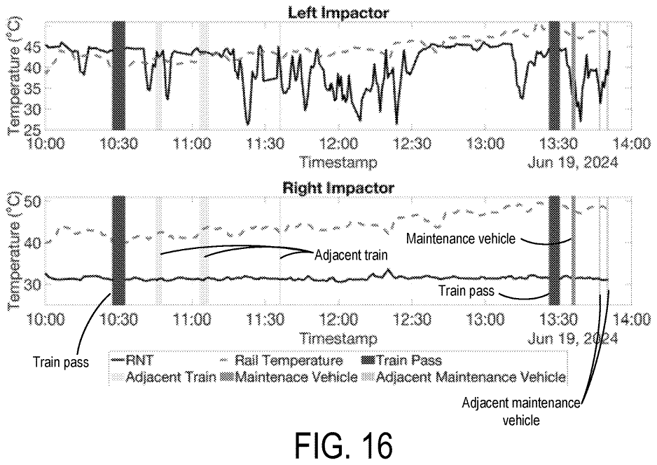

FIG. 16 shows the rail temperature measured with the thermocouples and the MLA-based RNT predictions. The value of the rail temperature is the average between the measurements at the railhead and the rail web. FIG. 16 also shows the moments when a freight train traveled along the same rail and an adjacent track. During train passes on the test rail, no data was collected while it was on adjacent passes. While the thermocouples agree well, the estimations from the two units differ significantly. Also, there are some unexpected peaks and valleys from the estimations obtained from the left unit (labelled as left impactor in FIG. 16). The estimation of the RNT equal to ~26 °C seems to be lower than expected but it may still be within a reasonable range given the severe winters affecting Western Pennsylvania. The right impactor does exhibit reasonable predictions around 32 °C given that NS sets their RNTs around 35 °C.

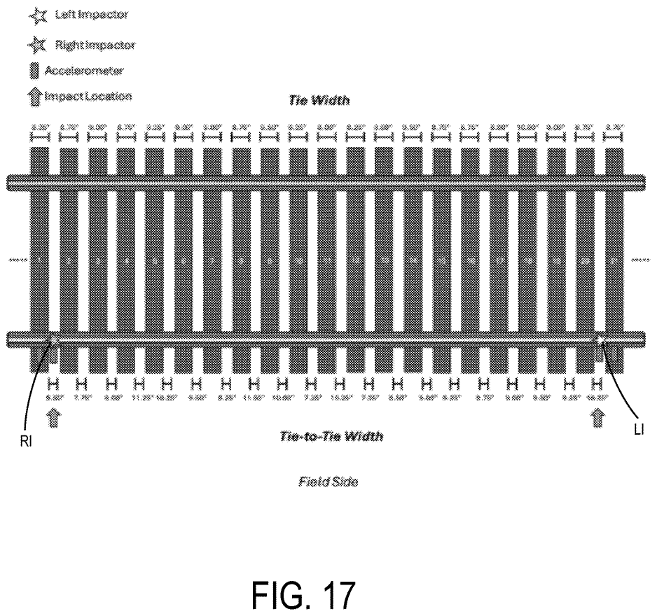

The second time (July 2024), the units were installed on a different track and placed about 6 meters (18 feet) apart (FIG. 17) to avoid the crosstalk noted during the previous experiments. This time, only 1.5% of the total recorded signals were discarded resulting in 1,626 lateral signals and 1,626 vertical waveforms available for the MLA analysis. In addition, the right unit was between two cross-ties that were located 413 mm (16.25 in.) apart instead of the 241 mm (9.5 in.) of the left unit. The effect of tie-to-tie distance on the individual peaks in the signals' spectrum was also evaluated. A setup change was also performed around 1:45 PM to determine the effect of a new fastening design on the rail. This change would not rely on clamping to the ties or adding weight to the foot of the rail, which were present in Pueblo and the first NS experiment.

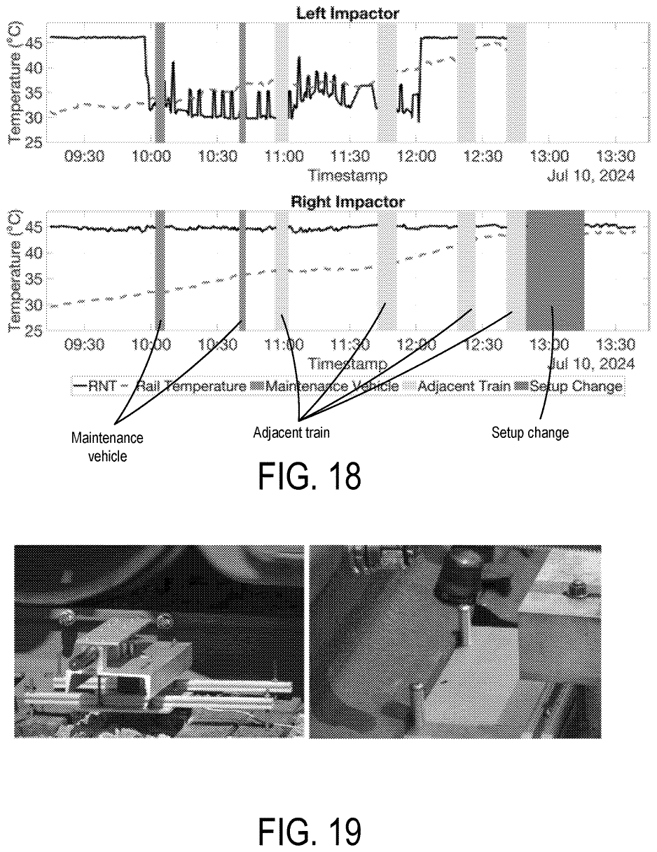

Similar to FIG. 16, FIG. 18 shows the average rail temperature measured with the thermocouples and the RNT predictions from the two units. Again, the left unit displays a behavior that remains under investigation. However, before 10 AM and after Noon, the two units predict a RNT of about 45 °C, which is higher than what would be expected at these latitudes. For both field campaigns, there was no noticeable effect by train activities. Significantly, these experiments were conducted blindly and are the estimations are still developmental. Also, as demonstrated by the retraining results of the model to 2024 Pueblo conditions, it is possible that the conditions being exposed to still vary to those available in our dataset. The setup change also had no impact on the predictions, further confirming its usefulness in the CSX test.

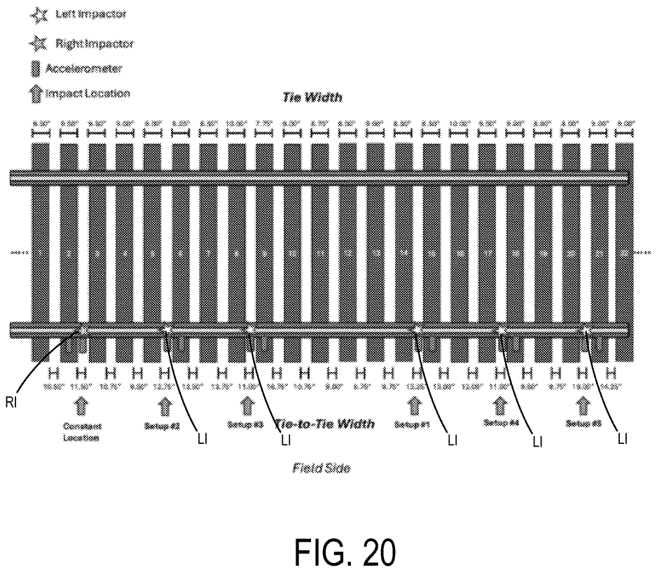

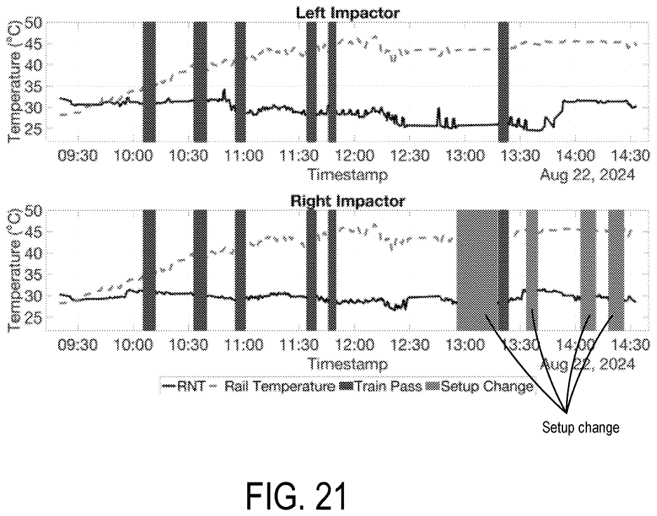

The third field test was conducted in August 2024 in collaboration with CSX. This time the wayside was not clipped to the rail foot and retained no reliance on clamping to the ties, enabling faster deployment and preventing any possibility of damage that could be accidentally applied to the cross ties. A close-up view of this arrangement is seen in FIG. 19. Several bolts are used as standoffs to provide additional friction to the device when impacting. The pins shown on the field side of the rail also reduce or prohibit kickback in the device while adding no weight to the rail itself. Note that the plate extends underneath the rail to another pin on the gage side, without physically having to touch the rail underneath. For this last experiment, the protocol was changed by keeping the left unit at the same location and installing the right unit at five locations throughout the day, as shown in FIG. 20. The original location is shown in setup #1 while the next four vary from very close to the left unit to furthest away. While the effect of the locations and the tie-to-tie distance is still ongoing, FIG. 21 shows that the RNT predictions overlapped to the readings of the rail temperatures. Both graphs present comparable estimations with the rail transitioning from tension to compression slightly after 9:30 AM, which is reasonable given that the experiment was conducted in August. Additionally, the move to the new clamps has provided stability in the signals over time resulting in stable predictions as well. Moving the right unit caused almost no change in the prediction of the neutral temperature, with the setup #2 showing a nearly identical RNT to the left unit. This makes sense as this was the closest of all the setups to the left impactor. Interestingly, there is a modest decrease in RNT, which is not what was observed in the 11 days of controlled track testing in Pueblo (CO). There are also no significantly apparent condition changes resulting from the freight trains active on the rail.

Table 1 summarizes relevant information about the field visits. The number of waveforms increased in subsequent visits, from the 179 signals collected in 2021 to the 4,454 signals stored in 2024.

TABLE 1
Summary table of instrumented rails tested in Pueblo (CO) in years 2021, 2022, and 2024.
WL = wireless. The rightmost column lists the number of the total time waveforms,
i.e., combining the waveform from all the accelerometers, collected in the field.

| | | | | Tie | Sensor | Impact | | # of |
|---|---|---|---|---|---|---|---|---|
| Year | Day # | Alignment | RE | material | type | locations | Site | signals |
| 2021 | 1 | Tangent | 136 | Wood | Wired | One | TTC | 70 |
| | | | | | | (manual) | | |
| 2021 | 2-3 | 5° curve | 141 | Concrete | Wired | One | TTC | 109 |
| | | | | | | (manual) | | |
| 2022 | 4-5 | Tangent | 136 | Wood | Wired | One | TTC | 512 |
| | | | | | and | (pendulum) | | |
| | | | | | WL | | | |
| 2022 | 6-7 | 5° curve | 141 | Concrete | Wired | One | TTC | 945 |
| | | | | | and | (pendulum) | | |
| | | | | | WL | | | |
| 2024 | 8-10 | Tangent | 136 | Wood | WL | Two | FAST | 3075 |
| | | | | | | (impactor) | | |
| 2024 | 11 | Tangent | 136 | Wood | WL | Two | FAST | 1379 |
| | | | | | | (impactor) | | |

In experiments, two analyses were conducted in which in the first analysis 1DCNN and 2DCNN models were trained using a combined 11-day dataset with a 50-50 split for training and testing (data unseen to the network). The analysis included a comparison among performances using different inputs. In the second analysis, the number of time-waveforms was augmented using additive white Gaussian noise (AWGN) at 10 dB and 20 dB signal-to-noise ratio (SNR). The same two CNNs were then retrained using the augmented dataset and tested to measure any bias improvement resulting from the original set.

To further measure the performance of both CNNs in learning a pattern that links the PSDs to the RNT, the inputs related to only the lateral and the vertical vibration components were considered. Table 2 summarizes these results and confirms that the combined use of both lateral and vertical directions shows improved performance. The information about vertical acceleration may contain information about torsional modes as well. Note that lateral direction for the 2DCNN shows a 0.25 °C improvement in error but performs worse on the 2022 and 2024 datasets, hence both directions were used as input for subsequent analysis.

TABLE 2
CNN performance comparison using different
accelerometer directions as input.

| | | Test MAE (°C) | | |
|---|---|---|---|---|
| Model | Direction | 2021 | 2022 | 2024 |
| 1DCNN | Both | 0.86 | 0.28 | 0.26 |
| | Lateral | 1.3 | 0.34 | 0.30 |
| | Vertical | 2.0 | 0.31 | 0.38 |
| 2DCNN | Both | 1.0 | 0.18 | 0.24 |
| | Lateral | 0.75 | 0.23 | 0.25 |
| | Vertical | 1.6 | 0.27 | 0.31 |

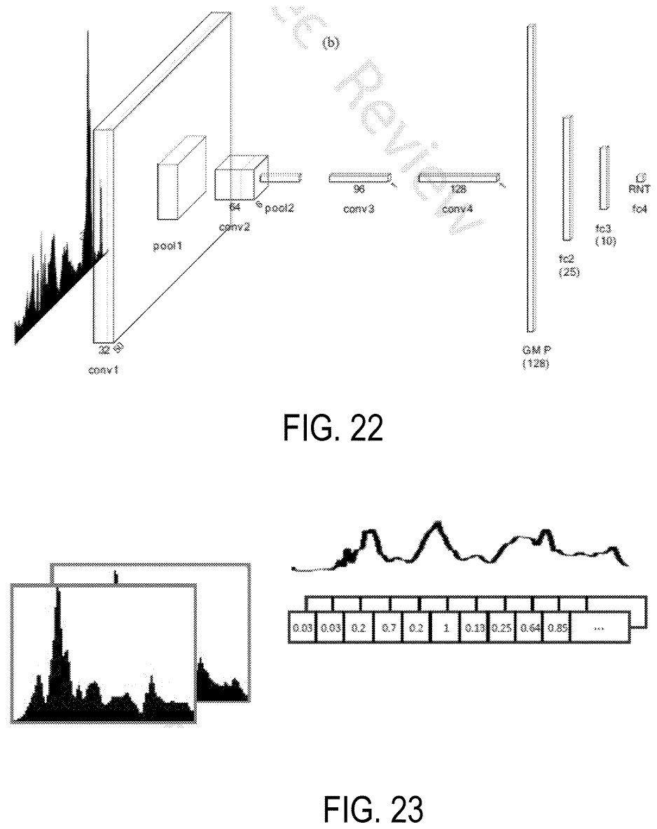

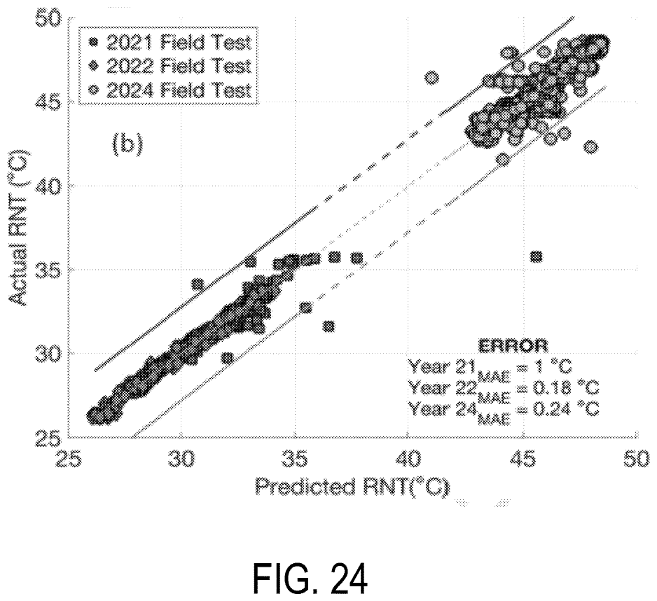

FIG. 22 shows an example architecture of a 2DCNN that can be used to estimate RNT. In some examples, inputs to 2DCNNs can correspond to restructured versions of the input signal of the 1DCNN, e.g., restructuring a 1DCNN into a 70×100×2 image to retain the same number of features present in the 1D-CNN (7000×2 vector representing both 162 directions at 0.1 Hz PSD resolution). Thus, while 1DCNN examples may use 1D filters for the vibration signal input, some 2DCNN examples can use 2D filters for spectral images converted from the original signal. As with 1DCNNs, MSE can be used to monitor best validation loss to avoid overfitting. FIG. 23 shows a comparison between 1DCNNs and 2DCNNs, with an example set of 2D inputs for a 2DCNN on the left and an example set of 1D inputs for a 1DCNN on the right.

FIG. 24 shows a graph of RNT prediction performance for a 2DCNN, which can be compared against the RNT prediction performance of a 1DCNN shown in FIG. 13. As can be seen from FIG. 24, the performance increases by about 0.1 °C in 2022 with nearly matching performance for 2024 between both networks. However, in 2021, there is a lag in performance compared to the 1DCNN with roughly a 0.14 °C increase in average error. Although the MAE in 2024 and 2022 is relatively small, the 2021 performance does include significant outliers, which may be due to an insufficient quantity of training data. However, all three years are within a desired accuracy of ±2.78 °C. As shown in the rightmost column of Table 1, the number of signals collected throughout the field trials is not uniform, and this can lead to data unbalance in deep learning algorithms. To investigate the effect of any potential bias, the number of time-waveforms from each day were increased to 486 by using AWGN to the original signals. AWGN takes the original signal sample X and adds Gaussian distributed noise centered around mean 0 using the following notation:

X_{aug}=X+\sqrt{P_{N}}*N(0,1)
where P_{N} represents the noise power. To determine P_{N}, the power of the signal P_{X} is used to determine the relative noise power at a specified SNR level (in our case 10 and 20 dB). Once determined, the gaussian variance was scaled to match the noise power. When a random variable is scaled by some k, its variance becomes k² so to maintain a variance P_{N}, it needs to be square rooted. The calculation step to P_{N} is:

$${P}_{N} = \frac{{P}_{N}}{{10}^{SNR / 10}}$$

After the noise was determined, the amount of data points to upsample each day was calculated. To level the amount of data across the three years, the data were augmented by a factor determined by the ratio of the largest sampled day in 2024 (baseline) to the day being augmented, in this case 486. This is simply represented as the quotient:

$$Scale = \frac{Baseline}{Day to Aug}$$

Neither the validation data nor the test data was injected with noise so that a performance measurement on unaugmented data was determined.

Table 3 compares the test performance of the two models trained using the original set as well as the augmented sets. When exposed to different levels of noise, the 2DCNN performs substantially better and is more robust to subtle changes triggered by noise injection than the 1DCNN. This is observed for 2022 where error rates are as much as 3 °C below those for the 1DCNN for 2022. Further, the introduction of 20 dB noise slightly improves the 2021 error to 0.99 °C over the original 2DCNN (1 °C) but remains inferior to the 1DCNN performance (0.86 °C). Although predictions are mostly within the desired accuracy, the addition of white noise does not ultimately benefit in learning intricate differences between certain signals with slightly different RNTs.

TABLE 3
Summary table of the additive noise analysis
across the 1DCNN and 2DCNN models.

| | | Test MAE (°C) | | |
|---|---|---|---|---|
| Model | Dataset | 2021 | 2022 | 2024 |
| 1DCNN | Original | 0.86 | 0.28 | 0.26 |
| | 10 dB | 1.3 | 2.4 | 1.2 |
| | 20 dB | 1.5 | 4.8 | 1.5 |
| 2DCNN | Original | 1.0 | 0.18 | 0.24 |
| | 10 dB | 1.2 | 0.87 | 0.71 |
| | 20 dB | 0.99 | 0.98 | 0.70 |

For the 2024 test on revenue service tracks, two wayside units were installed on a 60-mph tangent track with wooden sleepers. The first test took place in June 2024, followed by a second test about a month later at nearly the same location but on parallel track (discussed above). In both cases, the line was shut only to allow installation and removal, otherwise the line was open to regular business. Because no strain gauges were installed, this experiment was a pure blind test. Each impactor was clipped to the rail foot about 3 m. (10 ft.) apart. After filtering, 982 signals were retained. The same CNN models were applied. As one of the impactors showed issues, which emerged only after post-processing, the analysis of only one impactor is described next. The malfunctioning issues are attributed to slipping in the stepper motor that has caused poor impacts, periodically. This slippage led to a pattern of spiking energy in the spectrum every 11 to 12 impacts.

FIG. 25 shows the neutral temperature predicted by the 1DCNN and 2DCNN (original/uncorrupted) on the right unit, respectively. Each panel shows also the instantaneous temperature of the rail computed as the average between the web and head of the rail. Overall, both models predicted a state of compression throughout the monitoring period, given that the temperature T_{R} of the rail measured with thermocouples was higher than the estimated RNT. The predictions between both networks align very closely around 31 °C. Both networks also demonstrate stability over the span of the day from prediction to prediction. Given much of the physical signal for the 2DCNN is quantized into single pixels during the image reformatting process, the 2D convolution should exhibit a bit more invariance to subtle signal perturbations. Although the experiment was blind, i.e., without the presence of any strain-gage rosette, the monitored track segment was installed and welded one month earlier, when the applied pre-tension was such that T_{N}=35 °C.

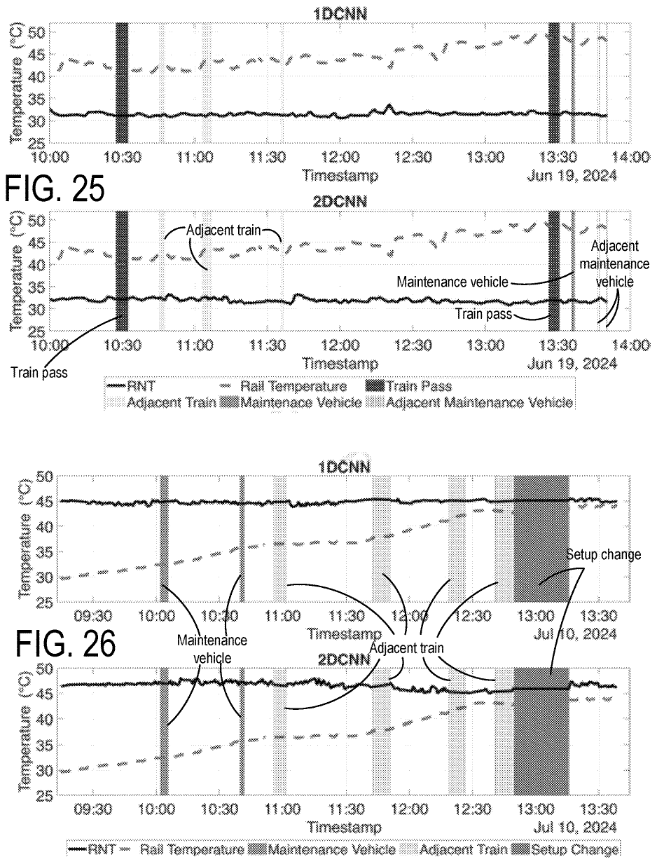

About a month later, the same unit was installed on a parallel track. The unit was fastened to the ties as done in in April 2024. A total of 813 lateral signals and 813 vertical waveforms were retained for MLA inference. The distance between the two cross-ties was equal to 413 mm (16.25 in.). At around 12:45 PM, a setup modification using resting standoffs instead of tie fastening was introduced to evaluate its feasibility. FIG. 26 shows the RNT predictions from both CNNs. The models predicted that the rail was under tension. Both networks agree again, showing confidence in the predictions that were made, though the value of 40-45 °C is higher than expected for Pittsburgh climate. FIG. 26 also demonstrates that the maintenance and operational activities carried on an adjacent track had no influence on the data. It cannot be excluded that the higher estimation of the neutral temperature is in part attributable to the spacing, 285.8 mm in June and 412.8 mm in July, between the two consecutive sleepers. The latter is much higher than the spacing of the tracks used for the training of the networks. At about 12:45 the setup was changed to test a new standoff-based fastener. This is seen with the latter large block area on the right of FIG. 26. The RNT is mostly constant during the time spent in the field, which can be attributed to the tracks being infinitely rigid in which the increase in the instantaneous temperature translates into increase in axial stress only. Given that the experiments were blind, without the support of any strain gage rosette system, the estimations presented FIGS. 25-26 are speculative.

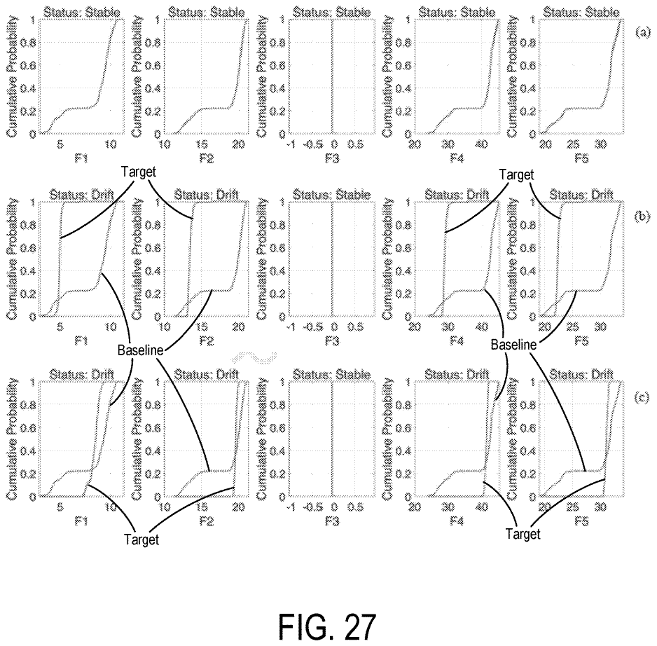

The overall analysis of the data from the revenue service lines shows that the 2DCNN marginally improved the predictive performance of the RNT in terms of stability. To gain more insights about the difference in the RNT predictions at the revenue service lines, a data drift analysis was conducted. In general, such analysis allows to determine if a given signal distribution has shifted from what the models were trained on. The Wasserstein distance was used as a drift and distance metric (sometimes referred to as earth mover's distance (EMD)). This metric can be superior to simple metrics such as cross-correlation because it can capture nonlinear changes and multivariate (multi-feature) relationships beyond two variables. Furthermore, correlation does not capture distribution shifts which are at the core of data drift. The Wasserstein distance is defined as the area between a baseline empirical cumulative density function (ECDF), which in this study is constituted by the training data, and a target ECDF, which is here represented by the revenue service data. When this area is zero, the ECDFs are overlapping, and the distribution has not shifted. As the area grows, so does the data drift. The Wasserstein distance W is defined as:

where w is the distance to move the mass of the CDF, Eb is the baseline ECDF, Et is the target ECDF, and their difference is the amount of mass that needs to be moved. The drift status is obtained based on permutation testing, which obtains a distribution for the Wasserstein metric over many possible arrangements in each feature for both the baseline and the target. In this experiment, the data was permuted 1000 times to obtain a sufficient distribution. A p-value can then be obtained based on how many of the metrics out of the total permutations were greater than the initial metric determined. If the lower confidence interval of the p-value is greater than 0.05, there is not sufficient evidence of drift. For clarity, a drift analysis of the baseline training set features with the target test set features was conducted and is shown in the top row of five graphs FIG. 27. The ten features from the fc3 layer (see FIG. 10 and FIG. 22) were extracted during inference on each signal. The top row of five graphs in FIG. 27 shows almost complete overlap between the training and test sets, with no drift detected on any of the features (F1-F5). For the sake of space, features F6-F10 are not shown. This can be explained by the fact that the hold out set is a subset of the exposed conditions and is expected to follow a similar distribution to the training. The middle row of five graphs in FIG. 27 shows instead the drift analysis on the ten features for the June NS test data. Looking closely, it can be seen that all features are labelled as drift with the exception of F3, which is because the weight on this feature is zero. Also noticeable, the CDFs lie in the lower range where attributes belonging to the 2021 and 2022 field tests belong. This is why the predictions all lie in the 31 °C range. The bottom row of five graphs of FIG. 27 for the July test shows the opposite, with most of the CDF being composed in the upper region. This upper region aligns with the 2024 feature attributes, which explains why higher RNT predictions around 45 °C were made. The results suggest that not only is there significant drift, but that the models likely require recalibration to account for the change in track conditions.

Thus, two deep learning (DL) models were compared when applied to the vibration data collected by an example wayside system configured to monitor the RNT of CWR. The 1-D and a 2-D CNN were compared against each other to gauge advantages to using one representation over the other at prediction the RNT. This was accomplished by transforming the signal into an image where each channel acts as a direction for the accelerometer. Amongst testing the networks against one another on an established training/test set, differing inputs were also explored, which consisted of using both directions, the vertical direction, or the lateral direction as input to determine the RNT. It was found that using both directions almost unanimously performed better than the two counterparts. With inputs established, data augmentation was performed to determine if a boost in performance could be attained. White gaussian noise at two different signal-to-noise ratios was added to the original training set, while refraining from any modification to the validation and test set to gauge generalization. The addition of noise for the 2-D CNN had some performance improvement on the 2021 data, which lacked the most data compared to the other two years but came at a cost in error to the 2022 and 2024 tests. It was observed that the addition of white noise also made it more difficult for the networks to learn the subtle differences between signals in relating to RNT. The two networks were then used to predict unlabeled revenue service data obtained on three field tests at Pittsburgh sites. Overall, the 2DCNN showcased promise in understanding more generalized features compared to the 1DCNN but does require an additional step in the pipeline to convert it an image. Additionally, the 2DCNN did not outperform the 1D representation by a significant margin. Rather, the networks performed nearly equally well when observing the original dataset results. Also, different environmental conditions between testing sites could present an out-of-distribution problem to the network. To this end a drift analysis was conducted and suggests that the field conditions may be significantly different.

With the demonstrated ability of deep learning to relate frequency content to RNT, there remains the difficulty of interpreting what PSD features are being used by the networks to predict RNT. The addition of known simulated data also assists in determining if the network is learning in a desirable way. This is particularly possible given known conditions afforded by simulation that are typically unavailable in the field (i.e., boundary conditions). The availability of simulation also supports the eventual determination of local stiffnesses in the tested rails. Furthermore, the implementation of an encoder can prevent poor impacts that pass through the filter process.

### GENERAL CONSIDERATIONS

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest,” “best,” “minimum,” or the like. It will be appreciated that such descriptions are intended to indicate that a selection among many used functional alternatives can be made, and such selections need not be better, smaller, or otherwise preferable to other selections.

Algorithms may be, for example, embodied as software or firmware instructions carried out by one or more digital computers. For instance, any of the disclosed RNT estimation techniques can be performed by a computer or other computing hardware (e.g., an ASIC or FPGA) that is part of an RNT measurement system. The RNT measurement system can be connected to or otherwise in communication with the a striker system and vibration detectors and be programmed or configured to perform measurement strikes and detect response vibrations, and to perform RNT measurement and estimate computations (e.g., any of the RNT estimation techniques disclosed herein). The computer can be a computer system comprising one or more processors (processing devices) and tangible, non-transitory computer-readable media (e.g., one or more optical media discs, volatile memory devices (such as DRAM or SRAM), or nonvolatile memory or storage devices (such as hard drives, NVRAM, and solid state drives (e.g., Flash drives)). The one or more processors can execute computer-executable instructions stored on one or more of the tangible, non-transitory computer-readable media, and thereby perform any of the disclosed techniques. For instance, software for performing any of the disclosed embodiments can be stored on the one or more volatile, non-transitory computer-readable media as computer-executable instructions, which when executed by the one or more processors, cause the one or more processors to perform any of the disclosed RNT measurement techniques. The results of the computations can be stored in the one or more tangible, non-transitory computer-readable storage media and/or can also be output to the user, for example, by displaying, on a display device (e.g., on the housing of the RNT system or sent to a mobile or remote device for display), detected vibration characteristics, RNT estimates, strike controls, etc., with a graphical user interface.

Having described and illustrated the principles of the disclosed technology with reference to the illustrated embodiments, it will be recognized that the illustrated embodiments can be modified in arrangement and detail without departing from such principles. For instance, elements of the illustrated embodiments shown in software may be implemented in hardware and vice-versa. Also, the technologies from any example can be combined with the technologies described in any one or more of the other examples. It will be appreciated that procedures and functions such as those described with reference to the illustrated examples can be implemented in a single hardware or software module, or separate modules can be provided. The particular arrangements above are provided for convenient illustration, and other arrangements can be used.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim all that comes within the scope of the appended claims.

We claim:

1. An apparatus, comprising:
a striker assembly including a base, a striker coupled to the base, a spring coupled to the striker, a spring compressor coupled to the spring to compress the spring and selectively release the striker to strike a continuous welded rail (CWR), and one or more fasteners coupled to the base and configured to removably secure the striker assembly in relation to the CWR.

2. The apparatus of claim 1, further comprising at least one detector removably couplable to the CWR in proximity to the position of the strike and configured to detect a vibration signal from the CWR produced in response to the strike and that is associated with a rail neutral temperature (RNT) of the CWR.

3. The apparatus of claim 2, wherein the at least one detector comprises a pair of accelerometers configured to magnetically attach to the CWR and to communicate wirelessly or wired to the controller.

4. The apparatus of claim 2, wherein the at least one detector comprises a non-contact laser source configured to direct a detection beam to the CWR and to communicate interferometric data wirelessly or wired to the controller.

5. The apparatus of claim 2, further comprising a controller including at least one processor and memory configured with processor-executable instructions, wherein the controller is in communication with the striker assembly to cause the spring compressor to compress the spring and to release the striker and in communication with the at least one detector to receive the detected vibration signal.

6. The apparatus of claim 5, wherein the controller is configured to estimate the RNT of the CWR by processing data associated with the detected vibration signal through a convolutional neural network trained on previously obtained detected vibration signals from other CWRs and ground truth RNTs associated with the previously obtained detected vibration signals.

7. The apparatus of claim 5, wherein the spring compressor includes a stepper motor coupled to the base and a gear rotatably coupled to the stepper motor and rotatably engaged to surfaces of the striker, wherein the stepper motor is configured to be controlled by the controller to rotate the gear to push against the surfaces to translate the striker and compress the spring.

8. The apparatus of claim 7, wherein the gear includes one or more toothless portions that when reached during rotation of the gear by the stepper motor causes the selective release of the striker to strike a continuous welded rail (CWR).

9. The apparatus of claim 5, wherein the striker comprises a rod with a first end coupled to the spring and an opposing second end that strikes the CWR, wherein at least one side of the rod includes notches that correspond to the surfaces that are rotatably engaged by the gear.

10. The apparatus of claim 5, wherein the spring compressor includes an electric plunger coupled to the base and to the striker to translate the striker and compress the spring.

11. The apparatus of claim 1, wherein the striker includes a replaceable tip that contacts a surface of the CWR during the strike.

12. The apparatus of claim 1, wherein the base includes at least two supports that extend generally transversely with respect to a direction of movement of the striker when released to strike the CWR, wherein the supports are configured to extend to contact two consecutive ties that support the CWR.

13. The apparatus of claim 12, wherein the one or more fasteners are configured to removably couple the supports to the two consecutive ties to secure the striker assembly in relation to the CWR.

14. The apparatus of claim 13, wherein the one or more fasteners include one or more of a clamp, adhesive, and/or screw.

15. The apparatus of claim 12, wherein the striker assembly includes standoff members coupled at first ends to the supports and at seconds ends to the two consecutive ties, and one or more posts coupled to the base at a position adjacent to the CWR to reduce a kickback associated with release of the spring, wherein the base is configured to extend under the CWR and clamp to an opposing side of the CWR.

16. The apparatus of claim 1, wherein the one or more fasteners comprise one or more magnets that couple the striker assembly to the CWR.

17. A method, comprising:
positioning a striker assembly in relation to a continuous welded rail (CWR) for measurement of a rail neutral temperature (RNT), such that the positioning does not interfere with a top surface of the CWR;
striking a side surface of the CWR using the striker assembly; and
detecting with a detector of the striker assembly that is coupled to the CWR, an vibration signal that is associated with the RNT of the CWR and that is produced in response to the striking of the CWR.

18. The method of claim 17, further comprising estimating the RNT of the CWR by processing the CWR vibration signal data through a convolutional neural network trained on previously obtained CWR vibration signal data and ground truth RNTs associated with the previously obtained CWR vibration signal data.

19. The method of claim 17, wherein the positioning comprises magnetically attaching the detector to the CWR.

20. The method of claim 17, wherein the striker assembly includes a base, a striker coupled to the base, a spring coupled to the striker, a spring compressor coupled to the spring, and one or more fasteners coupled to the base;
wherein the positioning comprises removably securing the striker assembly in relation to the CWR with the one or more fasteners;
wherein the striking comprises compressing the spring and selectively releasing the striker to strike the CWR.

21. The method of claim 20, wherein the striking comprises causing the spring compressor to compress the spring and to release the striker using a controller that is in communication with the striker assembly and that has at least one processor and memory configured with processor-executable instructions.

22. The method of claim 21, wherein the causing the spring compressor to compress the spring using the controller comprises controlling a stepper motor coupled to the base and to a gear rotatably engaged to surfaces of the striker, to rotate the gear to push against the surfaces to translate the striker and compress the spring.

23. The method of claim 22, wherein the causing the spring compressor to release the striker using the controller comprises controlling the stepper motor to rotate the gear to one or more toothless portions that cause the selective release.

24. The method of claim 22, wherein the striker comprises a rod with a first end coupled to the spring and an opposing second end that strikes the CWR, wherein at least one side of the rod includes notches that correspond to the surfaces that are rotatably engaged by the gear, wherein the striking comprises striking the CWR with the opposing second end.

25. The method of claim 24, wherein the opposing second end comprises a replaceable tip, wherein the striking comprises striking the CWR with the replaceable tip.

26. The method of claim 20, wherein the base includes at least two supports that extend generally transversely with respect to a direction of movement of the striker when released to strike the CWR, wherein the positioning the striker assembly in relation to a CWR comprises positioning the supports to extend to contact two consecutive ties that support the CWR.

27. The method of claim 26, wherein the positioning the striker assembly in relation to a CWR comprises removably coupling the supports to the two consecutive ties to secure the striker assembly in relation to the CWR with the one or more fasteners.

28. The method of claim 27, wherein the removably coupling with one or more fasteners comprises clamping, adhering, and/or screwing the supports to the two consecutive ties.

29. The method of claim 26, wherein the striker assembly includes standoff members coupled at first ends to the supports, and one or more posts coupled to the base, wherein the positioning the striker assembly in relation to a CWR comprises coupling second ends of the standoff members to the two consecutive ties, positioning the one or more posts adjacent to the CWR to reduce a kickback associated with release of the spring, and extending the base under the CWR and clamping the base to an opposing side of the CWR.

30. The method of claim 17, wherein the one or more fasteners comprise one or more magnets and the positioning the striker assembly in relation to a CWR comprises coupling the striker assembly to the CWR with the one or more magnets.

31. A method, comprising:
receiving continuous welded rail (CWR) vibration signal from a CWR striker system that impacts a CWR and detects a vibration signal in response; and
estimating a rail neutral temperature of the CWR by processing CWR vibration signal data associated with the vibration signal through a convolutional neural network trained on previously obtained CWR vibration signal data and ground truth RNTs associated with the previously obtained CWR vibration signal data.

32. The method of claim 31, further comprising pre-processing the CWR vibration signal data, wherein the pre-processing includes one or more of:
separating vibration signal events in the vibration signal based on threshold of minimum duration between consecutive samples;
filtering vibration signal data based on a commonality in timestamps between sensors associated with one striker system and sensors associated with another nearby striker system;
filtering vibration signal data where a plurality of vibration signals are detected during a time interval of consecutive strikes;
filtering vibration signal data where one of two or more sensors associated with a striker system does not capture a vibration captured by another of the two or more sensors associated with the striker system;
zero padding an end portion of each signal event in the dataset; and/or
filtering vibration signal data from the dataset where a lateral-to-vertical waveform component ratio for an event is outside an average distribution of lateral-to-vertical waveform component ratios for the dataset.

33. The method of claim 31, further comprising performing a min-max normalization of power spectral densities of the vibration signal, combining lateral components from two or more sensors into a single vector using frequency domain decomposition (FDD), and using the normalized CWR vibration signal data as the input to the convolutional neural network.

34. The method of claim 31, wherein the convolutional neural network is a one-dimensional convolutional neural network (1DCNN).

35. The method of claim 31, wherein the convolutional neural network is a two-dimensional convolutional neural network (2DCNN).

36. A computer readable medium having stored processor-executable instructions for carrying out method 17.

37. A method, comprising training the machine learning algorithm of claim 1.
